(19) United States
(12) Patent Application Publication
(10) Pub. No.: US 2025/0190226 A1
(43) Pub. Date: Jun. 12, 2025

(54) Interface Mapping Method And Apparatus

(71) Applicant: Siemens Aktiengesellschaft, München (DE)

(72) Inventors: Yi Peng Zhu, Jiangsu (CN); Tao Fei, Shanghai (CN)

(73) Assignee: Siemens Aktiengesellschaft, München (DE)

(21) Appl. No.: 18/841,089

(22) PCT Filed: Feb. 28, 2022
(86) PCT No.: PCT/CN2022/078308

§ 371 Date: Aug. 23, 2024

(51) Int. Cl. G06F 9/445; G06F 8/41

(52) U.S. Cl. CPC G06F 9/44505; G06F 8/427

(57) ABSTRACT

Various embodiments of the teachings herein include an interface mapping method. An example includes: converting an open application programming interface (API) description file of a microservice to a first communication standard interface description file; and mapping multiple parameter names in a functional interface in the first communication standard interface description file into a functional block corresponding to the functional interface.

### CROSS-REFERENCE TO RELATED APPLICATIONS

This application is a U.S. National Stage Application of International Application No. PCT/CN2022/078308 filed Feb. 28, 2022, the contents of which are hereby incorporated by reference in their entirety.

### TECHNICAL FIELD

The present application relates industry. Various embodiments of the teachings herein include interface mapping methods and/or apparatus.

### BACKGROUND

Low-code platforms provide a graphical user interface (GUI) containing reusable objects, allowing end users to develop their own service programs on low-code platforms at a low cost. If an application program constructed by a user in advance in an IT domain/OT domain is to be embodied in a low-code platform, so that the execution of the application program constructed in the IT domain/OT domain can be controlled via the low-code platform, one way of achieving this at present is to integrate as large a variety of communication standards as possible in the low-code platform, due to the fact that different application programs often use different communication standards; however, this method is very costly and requires a lot of effort. Conversely, another way is to have a low-code platform define its own platform standard, so that the process of an application program constructed by the user in the IT domain/OT domain must be established on this platform standard in order to be carried out, but this method obviously raises the barrier to entry.

### SUMMARY

The teachings of the present disclosure include interface mapping methods and apparatus for quickly and conveniently calling a functional interface of a microservice in a functional block of a low-code platform. For example, some embodiments include an interface mapping method comprising: converting an open API description file of a microservice to a first communication standard interface description file; mapping multiple parameter names in at least one functional interface in the first communication standard interface description file into a functional block corresponding to the functional interface.

As another example, some embodiments include an interface mapping apparatus comprising component parts for performing one or more of the methods described herein.

As another example, some embodiments include an electronic device comprising: at least one memory, configured to store computer-readable code; and at least one processor, configured to call the computer-readable code, to perform one or more of the methods described herein.

As another example, some embodiments include a computer-readable medium storing computer-readable instructions which, when executed by a processor, cause the processor to perform one or more of the methods described herein.

### BRIEF DESCRIPTION OF THE DRAWINGS

The drawings below illustrate and explain embodiments of the present application schematically, without limiting the scope thereof. In the drawings:

FIG. 1 is a flow chart of an example interface mapping method incorporating teachings of the present disclosure;

FIG. 2 is a schematic drawing of an example interface mapping method incorporating teachings of the present disclosure;

FIG. 3 is a schematic drawing of an example interface mapping apparatus incorporating teachings of the present disclosure; and

FIG. 4 is a schematic drawing of an example electronic device incorporating teachings of the present disclosure.

### KEY TO THE DRAWINGS

100: interface mapping method
101-102: method steps
30: interface mapping apparatus
31: microservice
32: file generator
33: OT domain parser
400: electronic device
401: memory
402: processor

### DETAILED DESCRIPTION

The teachings of the present disclosure are now discussed with reference to exemplary embodiments. It should be understood that the sole purpose of discussing these embodiments is to enable those skilled in the art to better understand and thereby implement the subject matter described herein, without limiting the protection scope, applicability, or examples expounded in the claims. Changes may be made to the functions and arrangement of the discussed elements without departing from the scope of protection of the content of embodiments of the present application. Various processes or components may be omitted from, replaced in or added to various examples as required. For example, the described method may be performed in a different order to that described, and various steps may be added, omitted or combined. Furthermore, features described in relation to some examples may also be combined in other examples.

As used herein, the term “comprising” and variants thereof denote open terms meaning “including but not limited to”. The term “based on” means “at least partly based on”. The terms “one embodiment” and “an embodiment” mean “at least one embodiment”. The term “another embodiment” means “at least one other embodiment”. The terms “first”, “second”, etc. may denote different or identical objects. Other definitions may be included below, whether explicit or implicit. Unless clearly specified in the context, the definition of a term is the same throughout the description.

A low-code platform includes computer software, which may be deployed on an IPC (industrial computer) or SBC (single-board computer), and may be expanded to processors, computers, processors, etc. It allows users to perform low-code development on a graphical user interface.

A workcell may be a system or equipment combination capable of realizing a relatively complete and independent control process and operation. In embodiments of the present application, workflows are created with workcells as the basic unit; this is more in keeping with the characteristics of industrial control, and can increase development integration while reducing development complexity. For example, taking the technical field of industry as an example, workcells may be defined according to the actual industrial scenario, e.g. one process may be defined to correspond to one workcell, or one workstation in a process may be defined as one workcell, or one machine in a workstation may be defined to correspond to one workcell, etc., with different workcells having different process flows.

FIG. 1 is a flow chart of an example interface mapping method incorporating teachings of the present disclosure. As shown in FIG. 1, the interface mapping method 100 comprises: Step 101, converting an open API description file of a microservice to a first communication standard interface description file; and Step 102, mapping multiple parameter names in at least one functional interface in the first communication standard interface description file into a functional block corresponding to the functional interface.

Generally, microservices are an architecture model or an architecture style which advocates dividing a single application program into a group of small services, each service running in its own independent process, the services being coordinated with each other and cooperating with each other, to provide final value to the user. Each service is constructed around a specific operation, and can be independently deployed to a production environment, production-like environment, etc. The specific implementation of workcells can be controlled via microservices. For example, a microservice providing component detection can be used to control a corresponding workcell to perform a component detection action.

An open API is an application of a service-type website; website service providers package their own website services as a series of APIs (application programming interfaces) and make them open to the public, for use by third party developers, and the APIs that are made open to the public are called open APIs.

A low-code platform may provide a user with operations to sequentially connect different functional blocks on a graphical user interface and perform instantiation configuration, to form a corresponding workflow, which may define operations to be performed by a workcell.

A functional interface in the first communication standard interface description file is an interface corresponding to a function in a microservice. For example, in the case of a microservice providing component detection, functional interfaces of the microservice include: a photography interface, a grabbing interface and a moving interface; by associating different functional interfaces with different functional blocks, and displaying the corresponding functional blocks as reusable objects on a graphical user interface, the user can drag out a preset object on the graphical user interface, to generate a corresponding functional block instance, and a functional interface of a microservice can be called quickly by means of the functional block instance, so as to control the execution of a function corresponding to this functional interface.

Embodiments of the present application may reduce the difficulty of integrating different application fields and low-code platforms. In addition, embodiments of the present application also offer users the possibility of combining different functional interfaces flexibly on a graphical user interface; not only can different functional interfaces in the same microservice by combined flexibly, but also, different functional interfaces of different microservices can be combined. Suppose that one microservice uses a first communication standard interface, while another microservice uses a second communication standard interface; then field differences of different access standards can be blocked by applying the present method, i.e. environment dependence is reduced.

In some embodiments, before the open API description file of the microservice is converted to the first communication standard interface description file, a portion of all the interfaces in the microservice may be exposed in the open API description file of the microservice by the user according to actual service requirements.

In some embodiments, the first communication standard may be an OT domain interface as well as an IT domain interface, and specifically may comprise: RESTful, Modbus, PROFINET or OPC UA, etc. Optionally, when the first communication standard interface is an IT domain interface, an OT domain low-code platform can control the execution of a microservice constructed by the IT domain by means of the present method. In this way, fast merging of the IT domain and the OT domain is achieved.

In some embodiments, all parameter names in at least one functional interface may be mapped into a functional block corresponding to the functional interface.

In some embodiments, after multiple parameter names in at least one functional interface in the first communication standard interface description file have been mapped into the functional block corresponding to the functional interface, a functional block interface description file may be generated. A workflow description file containing the functional block is generated according to the functional block interface description file. The workflow description file is run, and the first communication standard interface is called to control the execution of a function corresponding to the functional interface in at least one microservice.

In some embodiments, after multiple parameter names in at least one functional interface in the first communication standard interface description file have been mapped into the functional block corresponding to the functional interface, a functional block interface description file may be generated, and stored in a database.

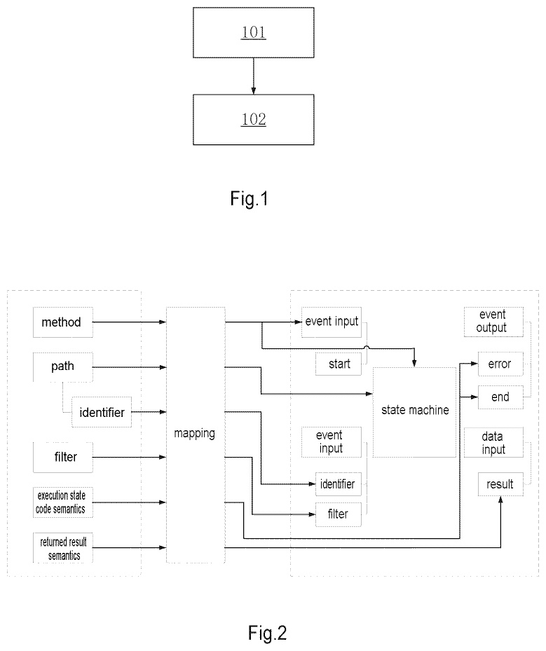

In some embodiments, the first communication standard interface is a Restful interface. The multiple parameter names include: method, path, filter, execution state code semantics and returned result semantics. In some embodiments, multiple parameter names in at least one functional interface in the Restful interface description file are mapped into a functional block corresponding to the functional interface. As shown in FIG. 2, the mapping method may comprise the following: a method is mapped to a start event in an event input port of a functional block, and the method is mapped into a first logic code of a state machine of the functional block; a path is mapped into a second logic code of the state machine of the functional block; an identifier in the path is mapped to a data input port of the functional block, and first data is added; a filter is mapped to a data input port of the functional block, and second data is added; execution state code semantics representing an error are mapped to an error event in an event output port of the functional block; and execution state code semantics representing termination are mapped to a termination event in the event output port of the functional block; and returned result semantics are mapped to a data output port of the functional block, and a first event is added.

In some embodiments, adding first data comprises adding first data with identifier as a name. In some embodiments, adding second data comprises adding second data with filter as a name. In some embodiments, adding a first event comprises adding a first event with result as a name. The purpose of this is to clarify the corresponding mapping relationship for the user, to facilitate management by the user.

In some embodiments, at least one functional interface in a Restful interface of a microservice can be called quickly and conveniently in a low-code platform. If the parameter names of all of the functional interfaces in the Restful interface are mapped into the corresponding functional blocks, all of the functional interfaces in the Restful interface of the microservice can thereby be called.

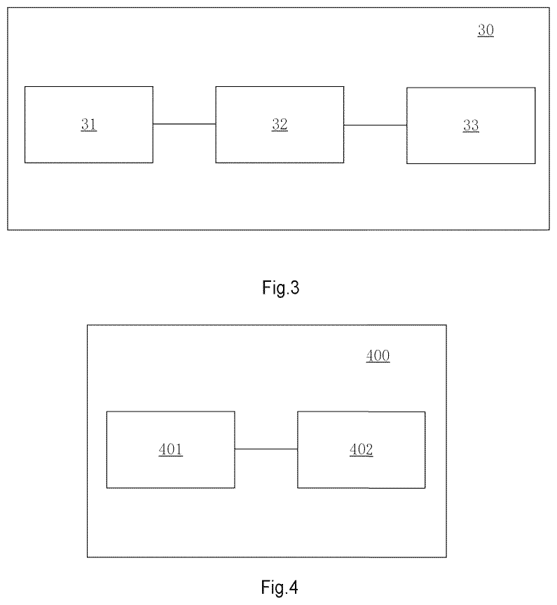

FIG. 3 is a schematic drawing of an example interface mapping apparatus 30 incorporating teachings of the present disclosure. As shown in FIG. 3, the interface mapping apparatus 30 comprises: a microservice 31, configured to: send an open API description file to a file generator 32; the file generator 32, configured to: convert the open API description file of the microservice to a first communication standard interface description file, and send the first communication standard interface description file to an OT domain parser 33; and the OT domain parser 33, configured to: map multiple parameter names in at least one functional interface in the first communication standard interface description file into a functional block corresponding to the functional interface.

OT domain equipment may include but is not limited to: Internet of Things (IoT) equipment, programmable logic controllers (PLC), robots (robotics), manual processes, industrial personal computers (IPC), etc.

IT domain equipment may include but is not limited to: manufacturing operation management (MOM) systems, manufacturing execution systems (MES), enterprise resource planning (ERP) systems, enterprise service buses (ESP), product lifecycle management (PLM) systems, etc.

Some embodiments include an electronic device. FIG. 4 is a schematic drawing of an example equipment control platform 400 incorporating teachings of the present disclosure. As shown in FIG. 4, the equipment control platform 400 comprises a processor 402 and a memory 401, the memory 401 having instructions stored therein, wherein the instructions, when executed by the processor 401, realize a method 100 as described herein.

The at least one processor 402 may comprise a microprocessor, an application-specific integrated circuit (ASIC), a digital signal processor (DSP), a central processing unit (CPU), a graphical processing unit (GPU), a state machine, etc. Embodiments of computer-readable media include but are not limited to floppy disks, CD-ROM, magnetic disks, memory chips, ROM, RAM, ASIC, configured processors, fully optical media, all magnetic tapes or other magnetic media, or any other media from which instructions can be read by a computer processor. In some embodiments, various other forms of computer-readable media can send or carry instructions to a computer, including routers, private or public networks, or other wired and wireless transmission devices or channels. The instructions may comprise code in any computer programming language, including C, C++, C language, Visual Basic, java and JavaScript.

Some embodiments include a computer-readable medium, having stored thereon computer-readable instructions which, when executed by a processor, cause the processor to perform one or more of the OT domain low-code development methods described herein. In some embodiments, computer-readable media include floppy disks, hard disks, magneto-optical disks, optical disks (e.g. CD-ROM, CD-R, CD-RW, DVD-ROM, DVD-RAM, DVD-RW, DVD+RW), magnetic tape, non-volatile memory cards and ROM. In some embodiments, computer-readable instructions may be downloaded from a server computer or the cloud via a communication network.

It should be explained that not all of the steps and modules in the procedures and system structure drawings above are necessary; certain steps or modules may be omitted according to actual needs. The order in which the steps are performed is not fixed and may be adjusted as needed. The system structures described in the embodiments above may be physical structures or logic structures, some modules might be realized by the same physical entity, or some modules might be realized by multiple physical entities separately, or may be realized jointly by certain components in multiple independent devices.

What is claimed is:

1. An interface mapping method-comprising:
converting an open application programming interface (API) description file of a microservice to a first communication standard interface description file; and
mapping multiple parameter names in functional interface in the first communication standard interface description file into a functional block corresponding to the functional interface.

2. The method as claimed in claim 1, wherein the first communication standard interface comprises an information technology (IT) domain interface.

3. The method as claimed in claim 1, wherein the first communication standard comprises at least one of: RESTful, Modbus, PROFINET, or OPC UA.

4. The method as claimed in claim 1, wherein
the first communication standard interface is a Restful interface; and
the multiple parameter names comprise: method, path, filter, execution state code semantics, and returned result semantics.

5. The method as claimed in claim 1, further comprising, after mapping multiple parameter names in at least one functional interface in the first communication standard interface description file into a functional block corresponding to the functional interface:
generating a functional block interface description file;
generating a workflow description file containing the functional block according to the functional block interface description file; and
running the workflow description file, and calling a first communication standard interface to control the execution of a function corresponding to at least one functional interface.

6. The method as claimed in claim 4, wherein mapping multiple parameter names in the functional interface in the Restful interface description file into a functional block corresponding to the functional interface comprises:
mapping a method to a start event in an event input port of the functional block; and mapping the method into a first logic code of a state machine of the functional block;
mapping a path into a second logic code of a state machine of the functional block;
mapping an identifier in the path to a data input port of the functional block, and adding first data;
mapping a filter to a data input port of the functional block, and adding second data;
mapping execution state code semantics representing an error to an error event in an event output port of the functional block; and mapping execution state code semantics representing termination to a termination event in an event output port of the functional block; and
mapping returned result semantics to a data output port of the functional block, and adding a first event.

7. The method as claimed in claim 6, wherein:
adding first data comprises adding first data with identifier as a name;
adding of second data comprises: adding second data with filter as a name; and
adding of a first event comprises adding a first event with result as a name.

8. An interface mapping apparatus comprising:
a microservice to send an open application programing interface (API) description file to a file generator;
the file generator to convert an open API description file of a microservice to a first communication standard interface description file, and send the first communication standard interface description file to an OT domain parser; and
the OT domain parser to map multiple parameter names in at least one functional interface in the first communication standard interface description file into a functional block corresponding to the functional interface.

9. An electronic device comprising:
at least one memory computer-readable code;
at least one processor to call the computer-readable code to:
convert an open application programming interface (API) description file a ice to a first communication standard interface description file; and
map multiple parameter names in a functional interface in the first communication standard interface description file into a functional block corresponding to the functional interface.

10. (canceled)
